(19) United States
(12) Patent Application Publication
(10) Pub. No.: US 2025/0088278 A1
(43) Pub. Date: Mar. 13, 2025

(54) OPTICAL AMPLIFIER PLACEMENT METHOD, OPTICAL AMPLIFIER PLACEMENT SUPPORT APPARATUS AND RELAY APPARATUS

(71) Applicant: NIPPON TELEGRAPH AND TELEPHONE CORPORATION, Tokyo (JP)

(72) Inventors: Ryo IGARASHI, Musashino-shi (JP); Kazutaka HARA, Musashino-shi (JP); Ryo KOMA, Musashino-shi (JP); Takahiro SUZUKI, Musashino-shi (JP)

(73) Assignee: NIPPON TELEGRAPH AND TELEPHONE CORPORATION, Tokya (JP)

(21) Appl. No.: 18/705,650

(22) PCT Filed: Dec. 6, 2021
(86) PCT No.: PCT/JP2021/044781

§ 371 Date: Apr. 29, 2024

(51) Int. Cl. H04B 10/291; H04B 10/293

(52) U.S. Cl. CPC H04B 10/2916; H04B 10/2935

(57) ABSTRACT

An optical amplifier arrangement method includes an acquisition step of acquiring transmission path information indicating a configuration of a network that transmits an optical signal via a plurality of relay nodes and a transmission path of the optical signal transmitted by the network; and a determination step of determining arrangement of optical amplifiers in the network by grouping a plurality of optical fibers passing through the same relay node based on the transmission path information, and determining whether optical amplification is required in each of the relay nodes for each group of the optical fibers.

### TECHNICAL FIELD

The present invention relates to optical amplifier placement method, an optical amplifier placement support apparatus and a relay apparatus.

### BACKGROUND ART

An optical signal transmitted from a transmitter in an optical transmission system is attenuated upon propagation due to transmission loss characteristics of an optical fiber. In a case where a signal intensity of an optical signal input to a receiver is lower than the minimum reception sensitivity, a bit error rate (BER) increases due to the influence of thermal noise generated in the receiver. Therefore, for example, when transmission has a large transmission loss, such as long-distance transmission, it is effective to compensate for a decrease in a signal intensity using an optical amplifier.

Amplified spontaneous emission (ASE) from an optical amplifier is light noise and may deteriorate reception characteristics of an optical signal. For example, even if the signal intensity of the optical signal input to the receiver is amplified to a higher level by means of the optical amplifier, the bit rate error increases in a case where the ASE has a larger signal intensity with respect to the signal light, that is, an optical signal-to-noise ratio (OSNR) is low. In order to suppress the increase in the bit error rate, it is important to keep the signal intensity of the optical signal input to the optical amplifier relatively and sufficiently high as compared to the ASE level emitted by the optical amplifier during optical amplification.

FIG. 20 is a diagram illustrating a change in a signal intensity with respect to a transmission distance (level diagram). FIG. 20 shows a transmission terminal 81 (Tx: transmitter) that is a user terminal on the transmission side, a reception terminal 82 (Rx: receiver) that is a user terminal on the reception side and three relay nodes 83 on the upper part. These three relay nodes 83 relay transmission of optical signals from the transmission terminal 81 (Tx) to the reception terminal 82 (Rx). Each of three relay nodes 83 is provided with an optical amplifier 84. Furthermore, FIG. 20 shows transition of the signal intensity of the optical signal due to attenuation caused by transmission loss characteristics of the optical fiber and due to amplification by the optical amplifier 84 on the lower part.

A threshold of the signal intensity at which the bit error rate increases due to the decreased OSNR is denoted by Pmin. As illustrated in FIG. 20, it is possible to suppress deterioration of reception characteristics caused by ASE by arranging the optical amplifier 84 such that the signal intensity is higher than Pmin in all sections in the transmission path.

As described above, it is important to keep the signal intensity relatively high in the transmission path in order to avoid the influence of the ASE. However, on the other hand, even in a case where the signal intensity is excessively high, waveform degradation occurs due to a nonlinear optical effect and thus the bit error rate increases (see Non Patent Literature 1). A threshold of the signal intensity at which the bit error rate increases due to the influence of the nonlinear optical effect is denoted by Pmax. Generally, in order to perform error-free transmission in a system that amplifies an optical signal at a relay node, it is important to design a transmission path so that a signal intensity in a transmission section is kept between Pmax, an upper limit value, and Pmin, a lower limit value.

Furthermore, FIG. 20 illustrates an example in a case where all the relay nodes 83 are provided with the optical amplifiers 84. However, it is important to reduce the number of optical amplifiers 84 to enable cost reduction. FIG. 21 is a diagram illustrating a change in a signal intensity with respect to a transmission distance (level diagram). FIG. 21 shows, similarly to FIG. 20, a transmission terminal 81 (Tx) that is a user terminal on the transmission side, a reception terminal 82 (Rx) that is a user terminal on the reception side and three relay nodes 83 on the upper part. These three relay nodes 83 relay transmission of optical signals from the transmission terminal 81 (Tx) to the reception terminal 82 (Rx).

The optical amplifiers 84 are provided only in some of the relay nodes 83 in FIG. 21 while the optical amplifiers 84 are provided at all the relay nodes 83 in FIG. 20. In particular, as compared with the case shown in FIG. 20, the optical amplifiers 84 of the second relay node 83 are thinned out from the transmission terminal 81 (Tx) side in FIG. 21. It should be noted that “thinning out the optical amplifiers 84” means “not disposing the optical amplifiers 84 (at the relay node 83)” in the following description.

Furthermore, similarly to FIG. 20, FIG. 21 shows transition of the signal intensity of the optical signal due to attenuation caused by transmission loss characteristics of the optical fiber and due to amplification by the optical amplifier 84 on the lower part. As illustrated in FIG. 21, even if the optical amplifiers 84 are partially thinned out, error-free transmission is enabled if the transmission loss between the plurality of relay nodes 83 is small and the signal intensity transitions between Pmax and Pmin. Therefore, some of the optical amplifiers 84 can be thinned to the extent in which the signal intensity transitions between Pmax and Pmin.

In recent years, studies on an all-optical network (photonic network) for further reducing delay and power consumption have been conducted (see, for example, Non Patent Literature 2). An all-optical network is a network that processes all transfer functions in an optical domain. FIG. 22 is a diagram illustrating one example of a configuration of an optical transmission system using the all-optical network. FIG. 22 shows a transmission terminal 81 (Tx) that is a user terminal on the transmission side, a reception terminal 82 (Rx) that is a user terminal on the reception side, a plurality of relay nodes 83, and a concentrator 85. Note that the concentrator 85 also serves as a relay node. Some of the relay nodes 83 are provided with the optical amplifiers 84, which are illustrated or not illustrated.

Furthermore, a transmission path of an optical signal from the transmission terminal 81 (Tx) to the reception terminal 82 (Rx) is indicated by a broken line arrow in FIG. 22. As shown in FIG. 22, the transmission path is a transmission path from the transmission terminal 81 (Tx) to the reception terminal 82 (Rx) via the relay node 83 without the optical amplifier 84, the relay node 83 with the optical amplifier 84 (relay node denoted by a symbol “B” in FIG. 22), the relay node 83 serving as the concentrator (relay node denoted by a symbol “A” in FIG. 22) and the relay node 83 with the optical amplifier 84 (relay node denoted by a symbol “C” in FIG. 22).

The all-optical network adopts an optical switch as a relay node. Accordingly, the all-optical network does not need to convert an optical signal to an electrical signal at a relay node before retransmission of the optical signal as in the conventional technology, and user terminals are connected to each other only by a transmission path of the optical signal. Furthermore, in a case where a transmission loss is large between the user terminals, an optical amplifier is arranged at each relay node to compensate for the transmission loss.

The network illustrated in FIG. 22 can be regarded as a network configured by a tree topology consisting of, for example, four layers as illustrated in FIG. 23. FIG. 23 is a diagram illustrating one example of a configuration of an optical transmission system using the all-optical network. Hereinafter, a case where a network is configured by a tree topology will be described as an example.

A network configured by a tree topology consisting of a 4-layered tree is assumed as illustrated in FIG. 24. FIG. 24 is a diagram illustrating one example of a configuration of an optical transmission system using the all-optical network. Optical signals herein are to be transmitted in a flow of lower layers (3rd and 4th layers), relay node 83 (B in FIG. 24), relay node 83 (A in FIG. 24), relay node 83 (C in FIG. 24) and lower layers (3rd and 4th layers) in this order. FIG. 24 shows a transmission path (01) of an optical signal from a transmission terminal 81 (Tx1), a user terminal on the transmission side, to a reception terminal 82 (Rx1), a user terminal on the reception side, which is indicated by a broken line arrow. FIG. 24 also shows a transmission path (02) of an optical signal from a transmission terminal 81 (Tx2), a user terminal on the transmission side, to a reception terminal 82 (Rx2), a user terminal on the reception side, which indicated by a dashed-and-dotted line arrow.

Hereinafter, reduction of the number of optical amplifiers 84 will be considered focusing on a user terminal group (Tx1 and Rx1) establishing communication via the transmission path (01) and a user terminal group (Tx2 and Rx2) establishing communication via the transmission path (02). For better understanding, all the optical amplifiers 84 are assumed to be an “output constant control” optical amplifier that outputs signals at a constant level of signal intensity. The signal intensity of signals output from all the optical amplifiers 84 is assumed to be equal to the signal intensity of signals output from the transmission terminals 81 (Tx1 and Tx2). Further, a transmission loss between the adjacent relay nodes 83 is assumed to be constant at any point.

A level diagram in the above case is illustrated in FIG. 25. FIG. 25 is a diagram illustrating a change in a signal intensity with respect to a conventional arrangement of optical amplifiers (level diagram). FIG. 25 shows the transmission terminals 81 (Tx1-1 to 1-3 and Tx2-1 to 2-3) that are user terminals on the transmission side, the reception terminals 82 (Rx1-1 to 1-3 and Rx2-1 to 2-3) that are user terminals on the reception side, and five relay nodes 83 on the upper part. These five relay nodes 83 relay transmission of optical signals from the transmission terminals 81 (Tx1-1 to 1-3 and Tx 2-1 to 2-3) to the reception terminals 82 (Rx1-1 to 1-3 and Rx2-1 to 2-3). Each of five relay nodes 83 is provided with an optical amplifier 84. Furthermore, FIG. 25 shows transition of the signal intensity of the optical signal due to attenuation caused by transmission loss characteristics of the optical fiber and due to amplification by the optical amplifier 84 on the lower part.

Assuming that communication is established using three optical fibers in each of the transmission path (01) and the transmission path (02), each relay node 83 (for example, A to C of FIG. 25) requires six optical amplifiers 84 as illustrated in FIG. 25. Hereinafter, a configuration in which the number of optical amplifiers 84 is reduced by thinning out the optical amplifiers 84 will be considered. A case where the number of optical amplifiers is optimized for each optical fiber will be described.

The following is a case where the number of optical amplifiers is optimized for each of six fibers in total in the transmission paths (01) and (02). FIG. 26 shows a configuration where the optical amplifiers 84 of relay nodes 83 disposed at odd-numbered positions counted from the side of the transmission terminals 81 (Tx1-1 to 1-3 and Tx2-1 to 2-3) are thinned out in FIG. 25. FIG. 26 is a diagram illustrating a change in a signal intensity with respect to a conventional arrangement of optical amplifiers (level diagram). FIG. 26 shows the transmission terminals 81 (Tx1-1 to 1-3 and Tx2-1 to 2-3) that are user terminals on the transmission side, the reception terminals 82 (Rx1-1 to 1-3 and Rx2-1 to 2-3) that are user terminals on the reception side, and five relay nodes 83 on the upper part. These five relay nodes 83 relay transmission of optical signals from the transmission terminals 81 (Tx1-1 to 1-3 and Tx 2-1 to 2-3) to the reception terminals 82 (Rx1-1 to 1-3 and Rx2-1 to 2-3).

The optical amplifiers 84 are provided only in some of the relay nodes 83 in FIG. 26 while the optical amplifiers 84 are provided at all the relay nodes 83 in FIG. 25. In particular, as compared with the case shown in FIG. 25, the optical amplifiers 84 of the relay nodes 83 disposed at odd-numbered positions counted from the side of the transmission terminals 81 (Tx1-1 to 1-3 and Tx2-1 to 2-3) are thinned out in FIG. 26.

Furthermore, FIG. 26 shows transition of the signal intensity of the optical signal due to attenuation caused by transmission loss characteristics of the optical fiber and due to amplification by the optical amplifier 84 on the lower part. As illustrated in FIG. 26, if the transmission loss between the relay nodes 83 is smaller than the output level from the optical amplifier 84 and the signal light intensity input to the optical amplifier 84 at the subsequent stage does not fall below Pmin, error-free transmission is enabled even when the optical amplifiers 84 are thinned out. Therefore, some of the optical amplifiers 84 can be thinned to the extent in which the signal intensity transitions between Pmax and Pmin.

In FIG. 26, respective transmission paths in the same transmission path group have the same configuration. “Respective transmission paths in the same transmission path group” refer to, for example, a transmission path from Tx1-1 to Rx1-1, a transmission path from Tx1-2 to Rx1-2, and a transmission path Tx1-3 to Rx1-3, out of the transmission path (01) group. In a case where the optical amplifiers 84 to be thinned out are selected by the same algorithm, the optical amplifier 84 of the same relay node 83 is selected between the transmission paths. Therefore, in this case, the optical amplifiers 84 are dedicated to the specific relay nodes 83.

For example, in a case where the optical amplifiers 84 disposed at odd-numbered positions (1, 3 and 5 in FIG. 26) counted from the transmission terminals 81 (Tx1-1 to Tx1-3 and Tx2-1 to Tx2-3) are thinned out as illustrated in FIG. 26, the optical amplifiers 84 are dedicated to the relay nodes 83 denoted by symbols “B” and “C” in FIG. 24. As illustrated in FIG. 26, six optical amplifiers 84 are required for each of the relay nodes 83 denoted by symbols “B” and “C”.

In the all-optical network, paths can be flexibly switched at a user's request. Hereinafter, a case where time elapses and the state of the transmission path of the network illustrated in FIG. 24 changes to the state of the transmission path of the network illustrated in FIG. 27 will be considered. FIG. 27 is a diagram illustrating another example of a configuration of an optical transmission system using the all-optical network. In contrast to FIG. 24 described above, FIG. 27 illustrates a state in which the transmission terminals 81 (Tx1-1 to 1-3 and Tx2-1 to 2-3) have moved from the position of the third layer to the position of the fourth layer in the tree topology. Accordingly, the transmission path (01) illustrated in FIG. 24 changes as a transmission path (03) in FIG. 27, and the transmission path (02) illustrated in FIG. 24 changes as a transmission path (04) in FIG. 27.

FIG. 28 shows a configuration where the optical amplifiers 84 disposed at odd-numbered positions counted from the side of the transmission terminals 81 (Tx1-1 to 1-3 and Tx2-1 to 2-3) are thinned out in the transmission paths (03) and (04). FIG. 28 is a diagram illustrating a change in a signal intensity with respect to a conventional arrangement of optical amplifiers (level diagram). FIG. 28 shows the transmission terminals 81 (Tx1-1 to 1-3 and Tx2-1 to 2-3) that are user terminals on the transmission side, the reception terminals 82 (Rx1-1 to 1-3 and Rx2-1 to 2-3) that are user terminals on the reception side, and six relay nodes 83 on the upper part. These six relay nodes 83 relay transmission of optical signals from the transmission terminals 81 (Tx1-1 to 1-3 and Tx 2-1 to 2-3) to the reception terminals 82 (Rx1-1 to 1-3 and Rx2-1 to 2-3).

As described above, respective transmission paths in the same transmission path group have the same transmission path configuration. In a case where the optical amplifiers 84 to be thinned out are selected on the basis of the same algorithm, the optical amplifier 84 of the same relay node 83 is selected between the transmission paths. For example, in a case where the optical amplifiers 84 of relay nodes 83 disposed at odd-numbered positions (1, 3 and 5 in FIG. 28) counted from the side of the transmission terminals 81 (Tx1-1 to Tx1-3 and Tx2-1 to Tx2-3) are thinned out as illustrated in FIG. 28, the optical amplifiers 84 are dedicated to the relay nodes 83 denoted by, for example, a symbol “A” in FIG. 27. As illustrated in FIG. 28, six optical amplifiers 84 are required for the relay node 83 denoted by, for example, a symbol “A”.

### CITATION LIST

### Non Patent Literature

Non Patent Literature 1: Ruben S. Luis et al., “Analytical Characterization of SPM Impact on XPM-Induced Degradation in Dispersion-Compensated WDM Systems”, Journal of Lightwave Technology, Vol. 23, No. 3, pp. 1503-1513, March 2005.
Non Patent Literature 2: H. Kawahara et al., “Optical Full-mesh Network Technologies Supporting the All-Photonics Network”, NTT Technical Review, Vol. 18, No. 5, pp. 24-29, May 2020.

### SUMMARY OF INVENTION

### Technical Problem

As described above, in a case where the number of optical amplifiers 84 is attempted to be reduced by thinning out the optical amplifiers 84 independently for each optical fiber, the positions of the relay nodes 83 at which the optical amplifiers 84 are thinned out are the same in the same transmission path group. Therefore, there are the relay nodes 83 to which the optical amplifiers 84 are dedicated. For example, in a network in which the transmission terminal 81 and the reception terminal 82 change their positions and the transmission path is switched over time and, such as the all-optical network, the positions of the relay nodes 83 to which the optical amplifiers 84 are dedicated also change over time.

For addressing such a change, the number of optical amplifiers 84 to be prepared for each relay node 83 in advance cannot be reduced, and conventionally, it is difficult to enable device cost reduction and space saving.

Considering the circumstances above, an object of the present invention is to provide a technology capable of reducing the number of optical amplifiers required to be arranged in a relay node.

### Solution to Problem

One aspect of the present invention is an optical amplifier arrangement method, including an acquisition step of acquiring transmission path information indicating a configuration of a network that transmits an optical signal via a plurality of relay nodes and a transmission path of the optical signal transmitted by the network; and a determination step of determining arrangement of optical amplifiers in the network by grouping a plurality of optical fibers passing through the same relay node based on the transmission path information, and determining whether optical amplification is required in each of the relay nodes for each group of the optical fibers.

Furthermore, another aspect of the present invention is an optical amplifier arrangement assistant device, including: an acquisition unit configured to acquire transmission path information indicating a configuration of a network that transmits an optical signal via a plurality of relay nodes and a transmission path of the optical signal transmitted by the network; and a determination unit configured to determine arrangement of optical amplifiers in the network by grouping a plurality of optical fibers passing through the same relay node based on the transmission path information, and to determine whether optical amplification is required in each of the relay nodes for each group of the optical fibers.

Furthermore, another aspect of the present invention is a relay device, including: an acquisition unit configured to acquire transmission path information indicating a configuration of a network that transmits an optical signal via a plurality of relay devices and a transmission path of the optical signal transmitted by the network; and a determination unit configured to determine arrangement of optical amplifiers in the network by grouping a plurality of optical fibers passing through this device itself or a plurality of optical fibers passing through the same relay device other than this device, based on the transmission path information, and to determine whether optical amplification is required in each of the relay devices for each group of the optical fibers.

### Advantageous Effects of Invention

According to the present invention, it is possible to reduce the number of optical amplifiers to be arranged in the relay node.

### BRIEF DESCRIPTION OF DRAWINGS

FIG. 1 is an overall configuration diagram of an optical transmission system using an all-optical network according to a first embodiment of the present invention.

FIG. 2 is a diagram illustrating one example of a configuration of a relay node in the optical transmission system according to the first embodiment of the present invention.

FIG. 3 is another overall configuration diagram of the optical transmission system using the all-optical network according to the first embodiment of the present invention.

FIG. 4 is a diagram illustrating another example of the configuration of the relay node in the optical transmission system according to the first embodiment of the present invention.

FIG. 5 is another overall configuration diagram of the optical transmission system using the all-optical network according to the first embodiment of the present invention.

FIG. 6 is a diagram illustrating one example of arrangement of optical amplifiers in the optical transmission system according to the first embodiment of the present invention.

FIG. 7 is another overall configuration diagram of the optical transmission system using the all-optical network according to the first embodiment of the present invention.

FIG. 8 is a diagram illustrating one example of the arrangement of the optical amplifiers in the optical transmission system according to the first embodiment of the present invention.

FIG. 9 is a diagram illustrating one example of the arrangement of the optical amplifiers in the optical transmission system according to the first embodiment of the present invention.

FIG. 10 is a flowchart illustrating an operation of a relay node 13 according to the first embodiment of the present invention.

FIG. 11 is an overall configuration diagram of an optical transmission system using an all-optical network according to a second embodiment of the present invention.

FIG. 12 is a diagram illustrating one example of arrangement of optical amplifiers in a conventional optical transmission system.

FIG. 13 is another overall configuration diagram of the optical transmission system using the all-optical network according to the second embodiment of the present invention.

FIG. 14 is a diagram illustrating one example of arrangement of optical amplifiers in the optical transmission system according to the second embodiment of the present invention.

FIG. 15 is a diagram illustrating one example of the arrangement of the optical amplifiers in the optical transmission system according to the second embodiment of the present invention.

FIG. 16 is a diagram illustrating one example of the arrangement of the optical amplifiers in the optical transmission system according to the second embodiment of the present invention.

FIG. 17 is a diagram illustrating another example of the arrangement of the optical amplifiers in the optical transmission system according to each embodiment of the present invention.

FIG. 18 is a diagram illustrating another example of the arrangement of the optical amplifiers in the optical transmission system according to each embodiment of the present invention.

FIG. 19 is a diagram illustrating another example of the arrangement of the optical amplifiers in the optical transmission system according to each embodiment of the present invention.

FIG. 20 is a diagram illustrating a change in a signal intensity with respect to an arrangement of optical amplifiers (level diagram).

FIG. 21 is a diagram illustrating a change in a signal intensity with respect to an arrangement of optical amplifiers (level diagram).

FIG. 22 is a diagram illustrating one example of a configuration of a conventional optical transmission system using an all-optical network.

FIG. 23 is a diagram illustrating one example of a configuration of the conventional optical transmission system using the all-optical network.

FIG. 24 is a diagram illustrating another example of the configuration of the conventional optical transmission system using the all-optical network.

FIG. 25 is a diagram illustrating a change in a signal intensity with respect to the conventional arrangement of optical amplifiers (level diagram).

FIG. 26 is a diagram illustrating a change in a signal intensity with respect to the conventional arrangement of optical amplifiers (level diagram).

FIG. 27 is a diagram illustrating another example of the configuration of the conventional optical transmission system using the all-optical network.

FIG. 28 is a diagram illustrating a change in a signal intensity with respect to the conventional arrangement of optical amplifiers (level diagram).

### DESCRIPTION OF EMBODIMENTS

Hereinafter, embodiments of the present invention will be described with reference to the drawings.

### First Embodiment

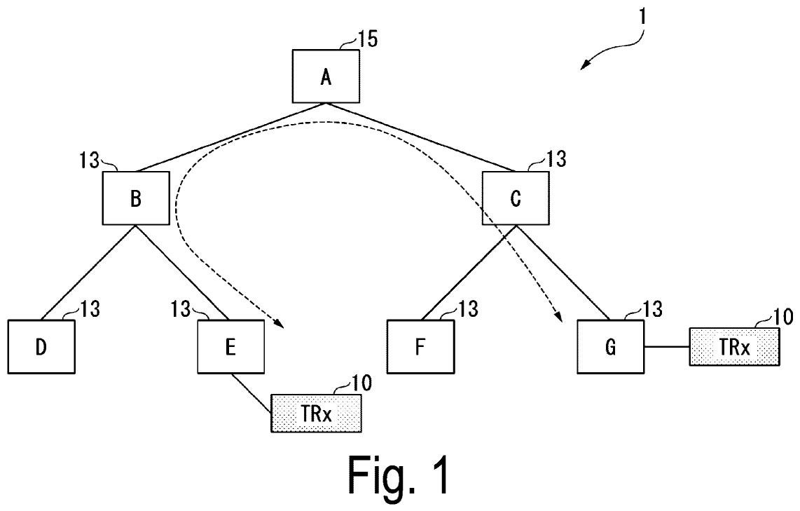

A first embodiment of the present invention will be described herein below. FIG. 1 is an overall configuration diagram of an optical transmission system 1 using an all-optical network according to a first embodiment of the present invention.

The all-optical network used in the optical transmission network of the first embodiment is a tree topology network consisting of a three-layered tree structure. FIG. 1 illustrates arrangement of a plurality of relay nodes 13 and a concentrator 15, both constituting the optical transmission system 1. The concentrator 15 also serves as a relay node. Furthermore, FIG. 1 illustrates two transceiver terminals 10 (TRx) which are user terminals exchanging communication with each other.

Some of the relay nodes 13 are provided with optical amplifiers 14 (not illustrated). In FIG. 1, symbols A to G are assigned to the respective relay nodes 13 so that they can be distinguished from each other in the following description. For example, the relay node 13 denoted by the symbol “A” can be sometimes referred to as “relay node A”, the relay node 13 denoted by the symbol “B” to as “relay node B” and so on.

As illustrated in FIG. 1, one transceiver terminal 10 (TRx) is connected to a relay node E, and the other transceiver terminal 10 (TRx) is connected to a relay node G. Hereinafter, as an example, a case where the transceiver terminal 10 (TRx) connected to the relay node E and the transceiver terminal 10 (TRx) connected to the relay node G have communication with each other will be described. A configuration of the relay node 13 will be described with a case of the relay node B herein below.

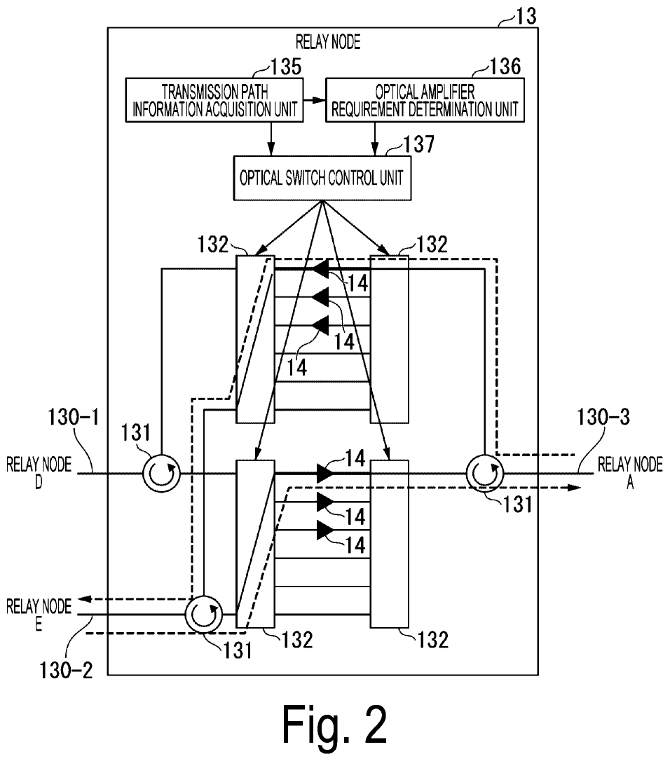

FIG. 2 is a diagram illustrating one example of the configuration of the relay node B (relay node 13) in the optical transmission system 1 according to the first embodiment of the present invention. As illustrated in FIG. 2, the relay node B is configured by including three input/output ports (input/output port 130-1, input/output port 130-2 and input/output port 130-3), three circulators 131, four optical switches 132, a transmission path information acquisition unit 135, an optical amplifier requirement determination unit 136, an optical switch control unit 137, and six optical amplifiers 14.

The input/output port 130-1 is connected to a relay node D illustrated in FIG. 1, the input/output port 130-2 is connected to a relay node E illustrated in FIG. 1, and the input/output port 130-3 is connected to a relay node A illustrated in FIG. 1.

An optical signal transmitted from the relay node A enters the relay node B from the input/output port 130-3. The optical signal that has entered the relay node B is separated by the circulator 131 for each traveling direction of the optical signal. The separated optical signal enters the optical switch 132 having a two-stage configuration. As illustrated in FIG. 2, some of the plurality of communication paths between two optical switches 132 have the optical amplifiers 14.

The optical switch 132 is configured to be able to select whether or on to allow the optical signal to pass the optical amplifier 14, and from which input/output port (input/output port 130-1 or 130-2) the optical signal is output by changing the selection of a communication path. The optical switch 132 outputs the optical signal from the selected input/output port.

An optical signal transmitted from the relay node D enters the relay node B from the input/output port 130-1. The optical signal that has entered the relay node B is separated by the circulator 131 for each traveling direction of the optical signal. The separated optical signal enters the optical switch 132 having a two-stage configuration. Some of the plurality of communication paths between two optical switches 132 have the optical amplifiers 14. The optical switch 132 is configured to be able to select whether or on to allow the optical signal to pass the optical amplifier 14 by changing the selection of a communication path. The optical switch 132 outputs the optical signal from the input/output port 130-3.

An optical signal transmitted from the relay node E enters the relay node B from the input/output port 130-2. The optical signal that has entered the relay node B is separated by the circulator 131 for each traveling direction of the optical signal. The separated optical signal enters the optical switch 132 having a two-stage configuration. Similarly to the above, the optical switch 132 is configured to be able to select whether or on to allow the optical signal to pass the optical amplifier 14 by changing the selection of a transmission path. The optical switch 132 outputs the optical signal from the input/output port 130-3.

FIG. 2 illustrates a case where an optical signal transmitted from the relay node A enters the relay node B from the input/output port 130-3, is separated by the circulator 131 for each traveling direction of the optical signal, and is output from the input/output port 130-2 to the relay node E via a communication path passing through the optical amplifier 14 by switching the communication path by the optical switch 132, as indicated by a broken line arrow. FIG. 2 also illustrates a case where an optical signal transmitted from the relay node E enters the relay node B from the input/output port 130-2, is separated by the circulator 131 for each traveling direction of the optical signal, and is output from the input/output port 130-3 to the relay node A via a communication path passing through the optical amplifier 14 by switching the communication path by the optical switch 132, as indicated by a broken line arrow.

The transmission path information acquisition unit 135 calculates a transmission path for connecting two transceiver terminals 10 (TRx) with a predetermined algorithm. The transmission path herein refers to, for example, a transmission path including the transceiver terminal 10 (TRx), relay node G, relay node C, relay node A, relay node B, relay node E, and transceiver terminal 10 (TRx) in this order as shown in FIG. 1. The transmission path information acquisition unit 135 outputs a configuration of the all-optical network and transmission path information indicating the calculated transmission path to the optical amplifier requirement determination unit 136 and the optical switch control unit 137, respectively.

The optical amplifier requirement determination unit 136 acquires the transmission path information output from the transmission path information acquisition unit 135. The optical amplifier requirement determination unit 136 determines whether the optical amplifier 14 is required for the relay node 13 (herein, the relay node B) with a predetermined algorithm on the basis of resource status of the entire optical transmission system 1, as indicated by the acquired transmission path information. The optical amplifier requirement determination unit 136 outputs optical amplifier requirement information indicating the determination result to the optical switch control unit 137.

The optical switch control unit 137 acquires the transmission path information output from the transmission path information acquisition unit 135 and the optical amplifier requirement information output from the optical amplifier requirement determination unit 136. The optical switch control unit 137 controls the setting of the transmission path by the optical switch 132 based on the optical amplifier requirement information notified from the optical amplifier requirement determination unit 136.

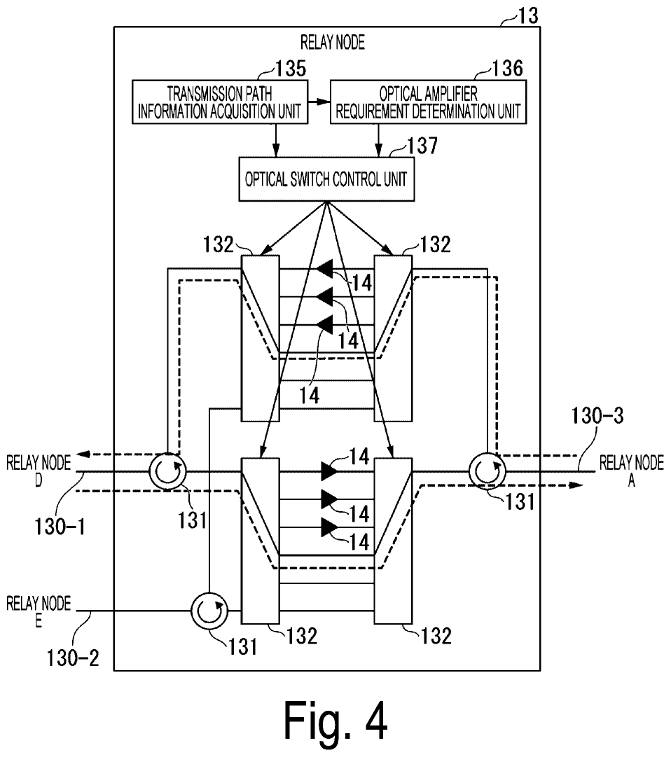

FIG. 2 and FIG. 4 (described later) show the configuration in which the transmission path information acquisition unit 135 and the optical amplifier requirement determination unit 136 are provided at the relay node 13 (relay device, relay apparatus), however the present invention is not limited thereto. The transmission path information acquisition unit 135 and the optical amplifier requirement determination unit 136 may be provided at a device other than the relay node 13 (relay device, relay apparatus), for example.

Hereinafter, as an example, a case where the input/output port 130-1 and the input/output port 130-3 are connected to the relay node B but the optical amplifiers 14 are thinned out will be described.

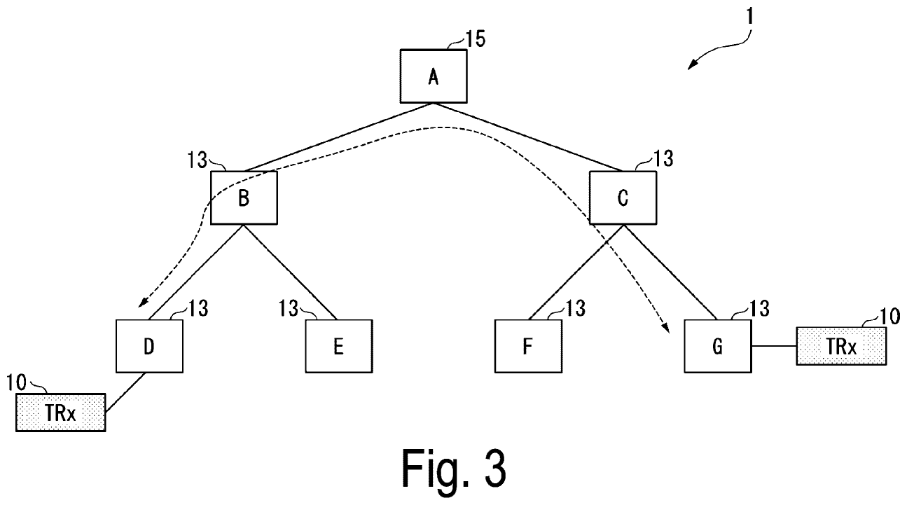

In this case, a transmission path within the all-optical network of the optical transmission system 1 is, for example, a transmission path indicated by a broken line arrow in FIG. 3. FIG. 3 is another overall configuration diagram of the optical transmission system 1 using the all-optical network according to the first embodiment of the present invention. The transmission path herein refers to a transmission path including the transceiver terminal 10 (TRx), relay node D, relay node B, relay node A (concentrator 15), relay node C, relay node G, and transceiver terminal 10 (TRx) in this order, or alternatively a transmission path including the same components in the reverse order, as shown in FIG. 3.

In this case, the transmission path at the relay node B is, for example, a transmission path indicated by a broken line arrow in FIG. 4. FIG. 4 is a diagram illustrating another example of the configuration of the relay node 13 in the optical transmission system 1 according to the first embodiment of the present invention.

FIG. 4 illustrates a case where an optical signal transmitted from the relay node A enters the relay node B from the input/output port 130-3, is separated by the circulator 131 for each traveling direction of the optical signal, and is output from the input/output port 130-2 to the relay node E via a communication path not passing through the optical amplifier 14 by switching the communication path by the optical switch 132, as indicated by a broken line arrow. FIG. 4 also illustrates a case where an optical signal transmitted from the relay node D enters the relay node B from the input/output port 130-1, is separated by the circulator 131 for each traveling direction of the optical signal, and is output from the input/output port 130-3 to the relay node A via a communication path not passing through the optical amplifier 14 by switching the communication path by the optical switch 132, as indicated by a broken line arrow.

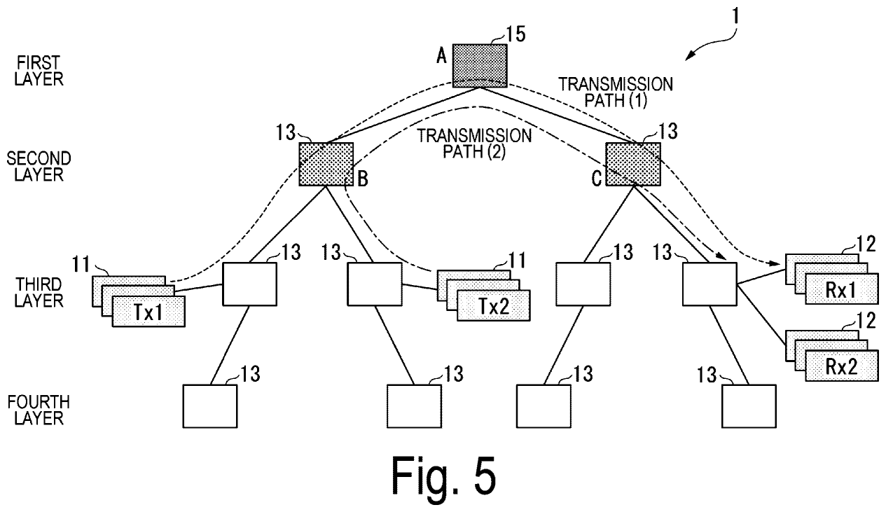

Hereinafter, for example, an algorithm used by the optical amplifier requirement determination unit 136 illustrated in FIGS. 2 and 4 to determine the relay node 13 from which the optical amplifiers 14 are thinned out will be described with reference to FIGS. 5 to 8.

Referring to FIG. 5, a method of thinning out the optical amplifier 14 and reducing the number of optical amplifier will be referred in a case where the transmission terminals 11 (Tx1 and Tx2) are located at a third layer of the tree topology in the all-optical network. FIG. 5 is another overall configuration diagram of the optical transmission system using the all-optical network according to the first embodiment of the present invention.

FIG. 5 illustrates a transmission path (1) connecting from the transmission terminal 11 (Tx1) to the reception terminal 12 (Rx1), as indicated by a broken line arrow, and a transmission path (2) connecting from the transmission terminal 11 (Tx2) to the reception terminal 12 (Rx2), as indicated by a dashed-and-dotted line arrow. The transmission path (1) refers to a transmission path including the transmission terminal 11 (Tx1), relay node 13, relay node B, relay node A (concentrator 15), relay node C, relay node 13, and reception terminal 12 (Rx1) in this order as shown in FIG. 5. The transmission path (2) refers to a transmission path including the transmission terminal 11 (Tx2), relay node 13, relay node B, relay node A (concentrator 15), relay node C, relay node 13, and reception terminal 12 (Rx2) in this order as shown in FIG. 5.

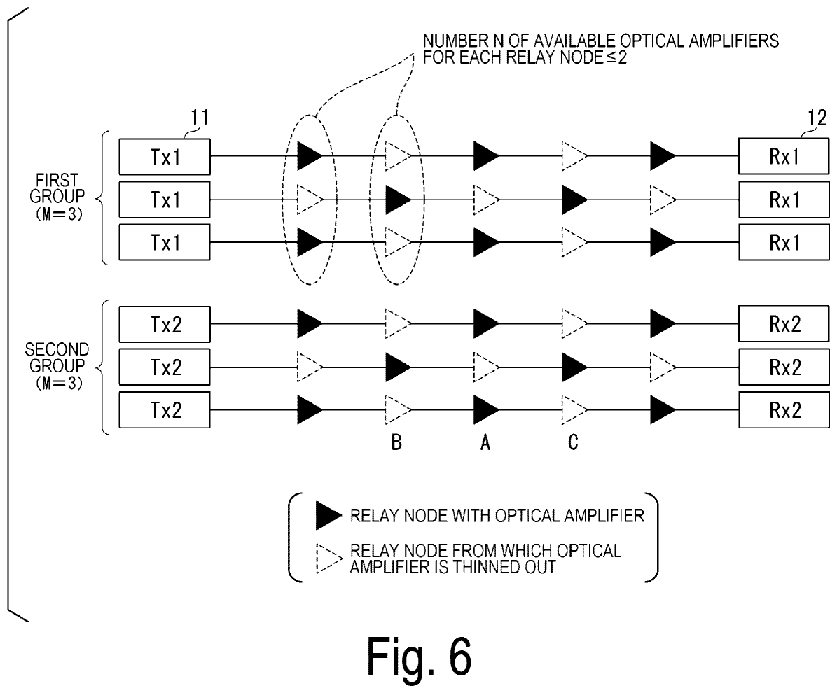

In each of the transmission paths (1) and (2), M optical fibers are grouped as one group. In each group, the upper limit of the number of available optical amplifiers 14 for each relay node 13 is assumed to be N. FIG. 6 illustrates one example where the optical amplifiers 14 are thinned out under such conditions.

FIG. 6 is a diagram illustrating one example of the arrangement of the optical amplifiers 14 in the optical transmission system 1 according to the first embodiment of the present invention. FIG. 6 shows the transmission terminals 11 (Tx1 and Tx2) that are user terminals on the transmission side, the reception terminals 12 (Rx1 and Rx2) that are user terminals on the reception side and five relay nodes 83. These five relay nodes 83 relay transmission of optical signals from the transmission terminals 81 (Tx1 and Tx2) to the reception terminals 82 (Rx1 and Rx2).

FIG. 6 illustrates a case where M=3 and N=2. FIG. 6 illustrates a first group in which three optical fibers included in the transmission path from the transmission terminal 11 (Tx1) to the reception terminal 12 (Rx1) are grouped, and a second group in which three optical fibers included in the transmission path from the transmission terminal 11 (Tx2) to the reception terminal 12 (Rx2) are grouped.

In this case, since the upper limit of available optical amplifiers 14 for each relay node 13 in each group is N as described above, the number of optical amplifiers 14 arranged in the relay node 13 in the first group and the number of optical amplifiers 14 arranged in the relay node 13 in the second group are each always not more than N. For example, as illustrated in FIG. 6, one optical amplifier 14 is required for each group in the relay nodes B and C, and two optical amplifier 14 are required for each group in the relay node A.

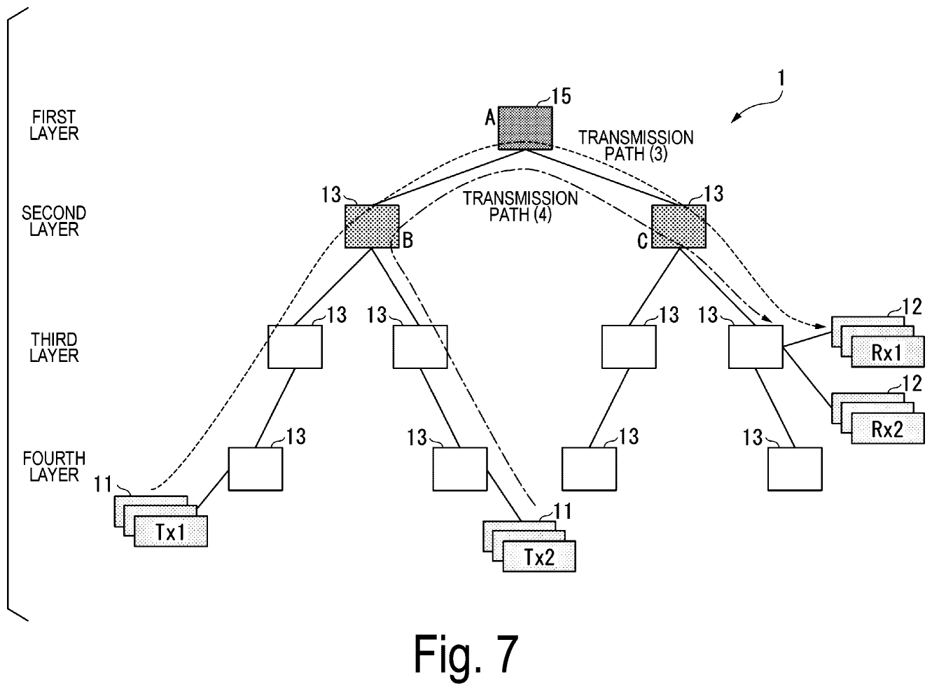

Referring to FIG. 7, a method of thinning out the optical amplifier 14 and reducing the number of optical amplifier will be referred in a case where the transmission terminals 11 (Tx1 and Tx2) are located at a fourth layer of the tree topology in the all-optical network. That is, a case where the transmission terminals 11 (Tx1 and Tx2) which have been located at the third layer of the tree topology as shown in FIG. 5 move to the fourth layer of the tree topology as shown in FIG. 7 will be considered. FIG. 7 is another overall configuration diagram of the optical transmission system using the all-optical network according to the first embodiment of the present invention.

FIG. 7 illustrates a transmission path (3) connecting from the transmission terminal 11 (Tx1) to the reception terminal 12 (Rx1), as indicated by a broken line arrow, and a transmission path (4) connecting from the transmission terminal 11 (Tx2) to the reception terminal 12 (Rx2), as indicated by a dashed-and-dotted line arrow. The transmission path (3) refers to a transmission path including the transmission terminal 11 (Tx1), relay node 13, relay node 13, relay node B, relay node A (concentrator 15), relay node C, relay node 13, and reception terminal 12 (Rx1) in this order as shown in FIG. 7. The transmission path (2) refers to a transmission path including the transmission terminal 11 (Tx2), relay node 13, relay node 13, relay node B, relay node A (concentrator 15), relay node C, relay node 13, and reception terminal 12 (Rx2) in this order as shown in FIG. 7.

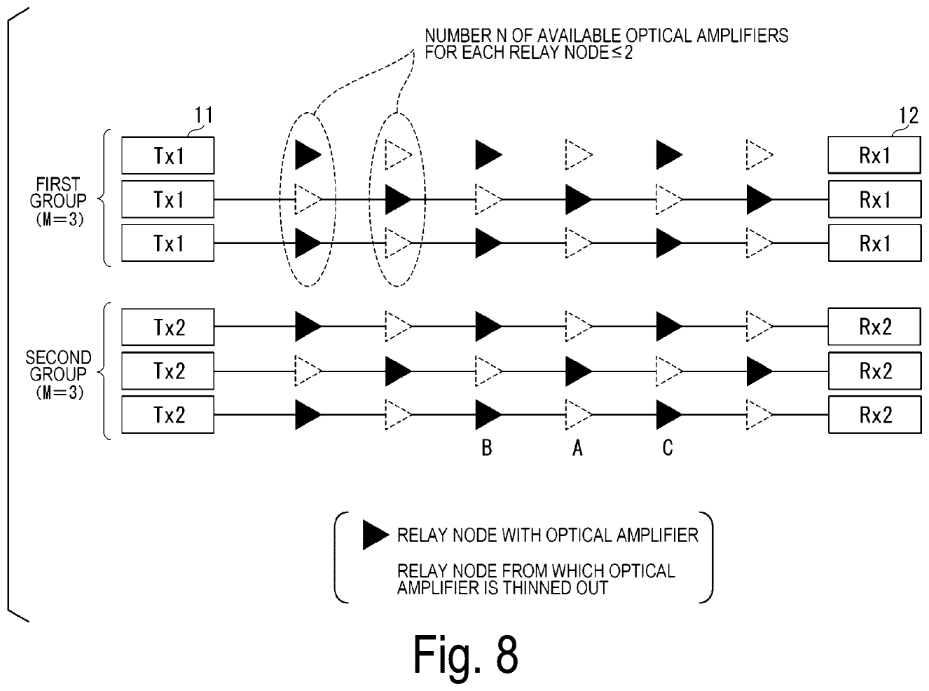

Similarly to the above, in each of the transmission paths (3) and (4), M optical fibers are grouped as one group. In each group, the upper limit of the number of available optical amplifiers 14 for each relay node 13 is assumed to be N. FIG. 8 illustrates one example where the optical amplifiers 14 are thinned out under such conditions.

FIG. 8 is a diagram illustrating one example of the arrangement of the optical amplifiers 14 in the optical transmission system 1 according to the first embodiment of the present invention. FIG. 8 shows the transmission terminals 11 (Tx1 and Tx2) that are user terminals on the transmission side, the reception terminals 12 (Rx1 and Rx2) that are user terminals on the reception side and six relay nodes 83. These six relay nodes 83 relay transmission of optical signals from the transmission terminals 81 (Tx1 and Tx2) to the reception terminals 82 (Rx1 and Rx2).

FIG. 8 illustrates a case where M=3 and N=2. FIG. 8 illustrates a first group in which three optical fibers included in the transmission path from the transmission terminal 11 (Tx1) to the reception terminal 12 (Rx1) are grouped, and a second group in which three optical fibers included in the transmission path from the transmission terminal 11 (Tx2) to the reception terminal 12 (Rx2) are grouped.

In this case, since the upper limit of available optical amplifiers 14 for each relay node 13 in each group is N as described above, the number of optical amplifiers 14 arranged in the relay node 13 in the first group and the number of optical amplifiers 14 arranged in the relay node 13 in the second group are each always not more than N. For example, as illustrated in FIG. 8, two optical amplifiers 14 are required for each group in the relay nodes B and C, and one optical amplifier 14 is required for each group in the relay node A.

As described above, the optical transmission system 1 according to the first embodiment of the present invention can prevent the optical amplifiers 14 from being dedicated to the specific relay node 13 by dispersedly arranging the optical amplifiers 14 for the plurality of optical fibers, even in a case where the transmission path is switched, thereby reducing the number of optical amplifiers 14 provided at the relay node 13 to be not more than N.

The example where M=3 and N=2 has been presented, however the number of optical fibers and optical amplifiers 14 are not limited thereto. That is, as long as the condition where “M optical fibers are grouped as one group in each transmission path and the upper limit of the number of available optical amplifiers 14 for each relay node in each group is N” is satisfied, M and N may be any numbers.

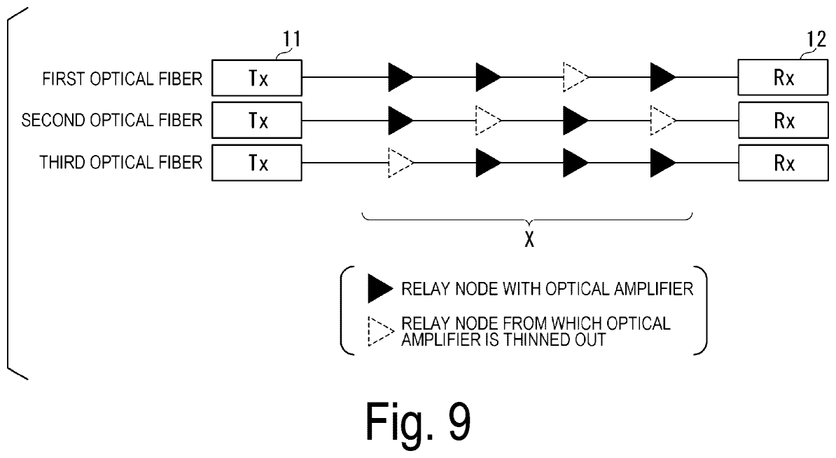

A method for calculating specific arrangement of the optical amplifiers 14 will be described with reference to FIG. 9. FIG. 9 is a diagram illustrating one example of the arrangement of the optical amplifiers in the optical transmission system according to the first embodiment of the present invention. FIG. 9 shows the transmission terminals 11 (Tx) that is a user terminal on the transmission side, the reception terminal 12 (Rx) that is a user terminal on the reception side and four relay nodes 83. These four relay nodes 83 relay transmission of optical signals from the transmission terminal 81 (Tx) to the reception terminal 82 (Rx).

As an example, a case where M=3 and N=2 will be considered hereinafter. FIG. 9 illustrates three optical fibers constituting one group as a first fiber, a second fiber and a third fiber.

In a certain relay node 13, a case where the optical amplifier 14 is provided for a certain optical fiber is represented by “1”, and a case where the optical amplifier 14 is thinned out is represented by “0”. For example, a state where the optical amplifiers 14 are provided for the first and second optical fibers and no optical amplifier 14 for the third fiber in a certain relay node 13 is represented by (1,1,0). In this case, since N is 2 as described above, there are three arrangement patterns of the optical amplifiers 14 in a certain relay node 13, i.e. (1,1,0), (1,0,1) and (0,1,1).

For example, in a case where each optical fiber passes through X relay nodes 13 in a certain transmission path and X is 4, possible arrangements for the optical amplifiers 14 in this transmission path are 3^{X}=3⁴=81 as illustrated in FIG. 9. For example, the arrangement of the optical amplifiers 14 that enable error-free transmission can be specified by calculating a bit error rate at the reception terminal 12 (Rx), out of all possible patterns, by means of transmission simulation with a computer.

In a case where the calculation result indicates that error-free transmission cannot be achieved in any of all arrangements, for example, calculation such as transmission simulation may be performed again with the increased value of N, which is the upper limit of the number of available optical amplifiers 14 for each relay node 13 in each group. By changing the condition, the number of required optical amplifiers 14 increases, however the possibility of specifying a configuration enabling error-free transmission can also be increased. Additionally, when focusing on reduction of the number of active optical amplifiers 14, the calculation may be performed under the condition where the number of optical amplifiers 14 for each relay node 13 is not more than N, instead of N.

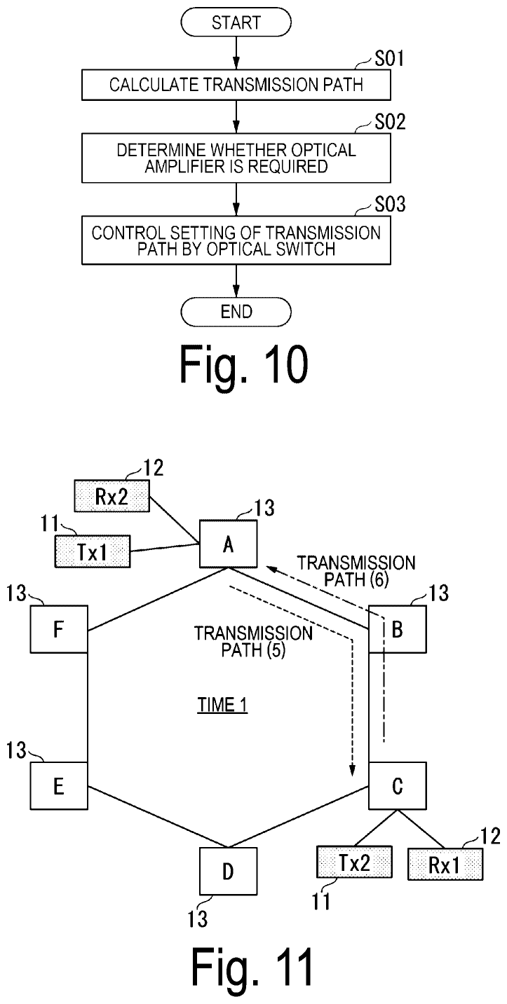

One example of an operation of the relay node 13 will be described herein below. FIG. 10 is a flowchart illustrating the operation of the relay node 13 according to the first embodiment of the present invention.

The transmission path information acquisition unit 135 (acquisition unit) of the relay node 13 calculates a transmission path for connecting two transceiver terminals 10 (TRx) with a predetermined algorithm (step S01). The transmission path information acquisition unit 135 outputs information on a configuration of the optical network and transmission path information indicating the calculated transmission path to the optical amplifier requirement determination unit 136 and the optical switch control unit 137, respectively.

The information (for example, information indicating arrangement, hierarchy of the relay nodes 13, and a relay node 13 to which two transceiver terminals 10 (TRx) are connected) on the configuration of the all-optical network of the optical transmission system 1, used for calculating a transmission path, may be, for example, a configuration stored in the relay node 13 in advance, or alternatively, appropriately transmitted via the network, for example.

The optical amplifier requirement determination unit 136 (determination unit) acquires the transmission path information output from the transmission path information acquisition unit 135. The optical amplifier requirement determination unit 136 determines whether the optical amplifier 14 is required for the relay node 13 with a predetermined algorithm on the basis of resource status of the entire all-optical network, as indicated by the acquired transmission path information (step S02). The optical amplifier requirement determination unit 136 outputs optical amplifier requirement information indicating the determination result to the optical switch control unit 137.

The optical switch control unit 137 acquires the transmission path information output from the transmission path information acquisition unit 135 and the optical amplifier requirement information output from the optical amplifier requirement determination unit 136. The optical switch control unit 137 controls the setting of the transmission path by the optical switch 132 based on the optical amplifier requirement information notified from the optical amplifier requirement determination unit 136 (step S03). The operation of the relay node 13 illustrated in the flowchart of FIG. 10 ends.

Details of the operation of the optical amplifier requirement determination unit 136 in step S02 are, for example, as follows. The optical amplifier requirement determination unit 136 groups a plurality of optical fibers passing through the same relay node 13 on the basis of the transmission path information, and determines whether optical amplification is required per relay node 13 for each optical fiber group to determine the arrangement of the optical amplifiers 14 in the all-optical network.

For example, the optical amplifier requirement determination unit 136 performs, in a case where the number of optical fibers grouped in the relay node 13 is M and the number of optical amplifiers 14 per relay node 13 of each group is N, simulation of transmission of the optical signal for possible patterns made by combinations of M and N values, and determines the arrangement of the optical amplifiers 14 on the basis of simulation results. For example, the optical amplifier requirement determination unit 136 calculates a bit error rate in the reception terminal 12 (Rx) for receiving the optical signal for each of the patterns by means of the simulation, and determines the arrangement of the optical amplifiers 14 based on the calculated bit error rate.

For example, the optical amplifier requirement determination unit 136 determines the arrangement of the optical amplifiers 14 so that a signal intensity of the optical signal passing through the relay node 13 transitions between the signal intensity (Pmax) influenced by the nonlinear optical effect and the signal intensity (Pmin) at which the bit error rate increases due to a decrease in the optical signal-to-noise ratio (OSNR).

As described above, the optical transmission system 1 according to the first embodiment of the present invention can appropriately thin out the optical amplifiers 14 in the network in which positions of user terminals and transmission paths change over time.

The conventional optical transmission system compensates for a decreased in the signal light intensity using the optical amplifiers in order to achieve long-distance transmission. The optical amplifiers arranged at all the nodes in the optical transmission system increase the cost. However, error-free transmission can be enabled by arranging the optical amplifiers so that the signal light intensity transitions between Pmax (signal intensity influenced by the nonlinear optical effect) and Pmin (signal intensity at which a bit error rate increased due to the decreased OSNR), even if some of the optical amplifiers are thinned out.

However, in a case where the number of optical amplifiers is minimized independently for each fiber, the number of optical amplifiers to be prepared for each node cannot be reduced in a network (e.g. all-optical network) in which a transmission path is switched over time, because a node to which the optical amplifiers are dedicated varies over time.

On the other hand, the optical transmission system 1 of the first embodiment groups the adjacent optical fibers passing through the same relay node as one group, and determines the arrangement of the optical amplifiers 14 per group, not per optical fiber. As described above, the optical transmission system 1 prevents the optical amplifiers 14 from being dedicated to the specific relay node 13 by dispersedly arranging the optical amplifiers 14 provided at the relay node 13 for each group.

The optical transmission system 1 determines the arrangement of the optical amplifiers 14 so that the number of optical amplifiers 14 for each relay node 13 becomes, for example, not more than N. The optical transmission system 1 sets the number of optical fibers to be grouped to M and the upper limit of the number of optical amplifiers 14 for each relay node 13 of each group to N, and performs calculation such as transmission simulation for all possible patterns that can be made from combinations of M and N values.

Accordingly, the optical transmission system 1 is capable of finding a combination that the optical amplifiers 14 can be installed to enable error-free transmission and the number of optical amplifiers 14 can be further reduced. Therefore, the optical transmission system 1 according to the first embodiment of the present invention can reduce the number of optical amplifiers 14 to be provided at the relay node 13.

### Second Embodiment

Hereinafter, a second embodiment of the present invention will be described. In the first embodiment described above, the case where the all-optical network used in the optical transmission network is a tree topology network has been considered. In the second embodiment described below, a case where the all-optical network used in the optical transmission network is a link topology network will be considered.

FIG. 11 is an overall configuration diagram of an optical transmission system using an all-optical network according to the second embodiment of the present invention. The all-optical network used in the optical transmission network of the second embodiment is a link topology network. FIG. 11 illustrates arrangement of a plurality of relay nodes 13 constituting the optical transmission system. Furthermore, FIG. 11 illustrates two sets of user terminals that establish communication with each other: a transmission terminal 11 (Tx1) and a reception terminal 12 (Rx1); and a transmission terminal 11 (Tx2) and a reception terminal 12 (Rx2).

Some of the relay nodes 13 are provided with optical amplifiers 14 (not illustrated). In FIG. 11, symbols A to G are assigned to the respective relay nodes 13 so that they can be distinguished from each other in the following description. For example, the relay node 13 denoted by the symbol “A” can be sometimes referred to as “relay node A”, the relay node 13 denoted by the symbol “B” to as “relay node B” and so on.

In FIG. 11, as one example, a transmission path (5) is indicated by a broken line arrow and a transmission path (6) is indicated by a dashed-and-dotted line arrow at a certain time (time 1). The transmission path (5) refers to a transmission path including the transmission terminal 11 (Tx1), relay node A, relay node B, relay node C, and reception terminal 12 (Rx1) in this order as shown in FIG. 11. The transmission path (6) refers to a transmission path including the transmission terminal 11 (Tx2), relay node C, relay node B, relay node A, and reception terminal 12 (Rx2) in this order as shown in FIG. 11.

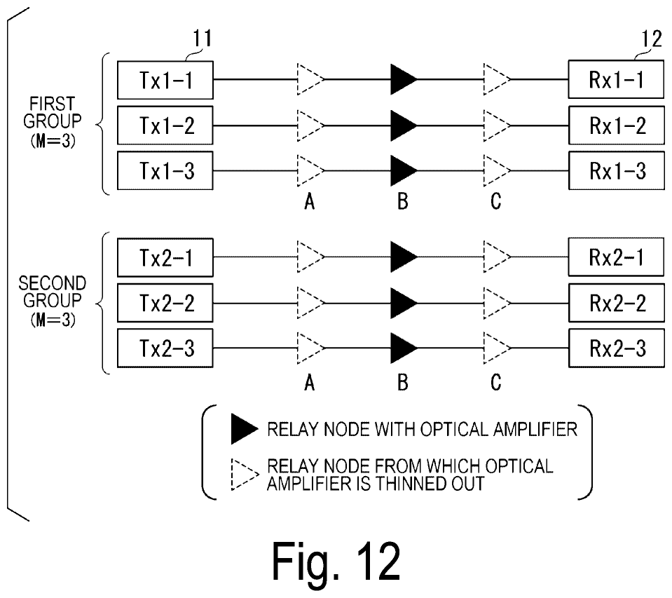

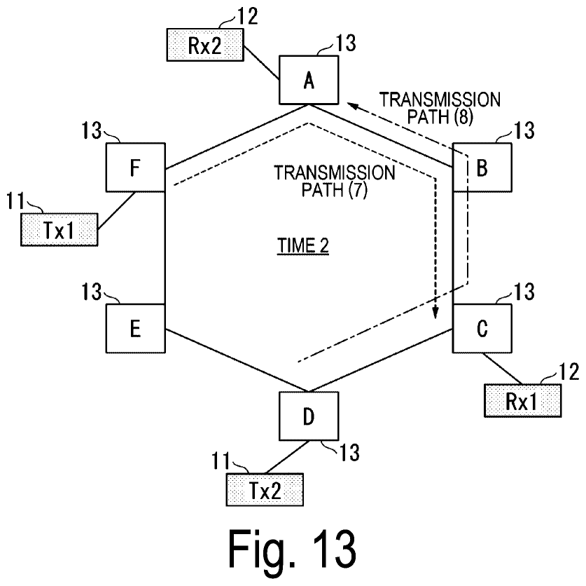

As in the related art, in a case where it is attempted to reduce the number of optical amplifiers 14 per optical fiber, the number of required optical amplifiers 14 is dedicated to the relay node B, and each transmission path requires three optical amplifiers 14 as illustrated in, for example, FIG. 12. FIG. 12 is a diagram illustrating one example of arrangement of optical amplifiers in a conventional optical transmission system. FIG. 12 shows the transmission terminals 11 (Tx1-1 to 1-3 and Tx2-1 to 2-3) that are user terminals on the transmission side, the reception terminals 12 (Rx1-1 to 1-3 and Rx2-1 to 2-3) that are user terminals on the reception side, and three relay nodes 83. These three relay nodes 83 relay transmission of optical signals from the transmission terminals 81 (Tx1-1 to 1-3 and Tx 2-1 to 2-3) to the reception terminals 82 (Rx1-1 to 1-3 and Rx2-1 to 2-3). In such a case, one example where a time has elapsed from the time 1 illustrated in FIG. 11 to the time 2 illustrated in FIG. 13 will be considered.

FIG. 13 is an overall configuration diagram of the optical transmission system using the all-optical network according to the second embodiment of the present invention. Similar to FIG. 11, the all-optical network of the optical transmission network as illustrated in FIG. 13 is a link topology network. FIG. 11 illustrates arrangement of a plurality of relay nodes 13 constituting the optical transmission system. Furthermore, FIG. 11 illustrates two sets of user terminals that establish communication with each other: a transmission terminal 11 (Tx1) and a reception terminal 12 (Rx1); and a transmission terminal 11 (Tx2) and a reception terminal 12 (Rx2).

In FIG. 13, as one example, a transmission path (7) is indicated by a broken line arrow and a transmission path (8) is indicated by a dashed-and-dotted line arrow at a certain time (time 2). The transmission path (7) refers to a transmission path including the transmission terminal 11 (Tx1), relay node F, relay node A, relay node B, relay node C, and reception terminal 12 (Rx1) in this order as shown in FIG. 13. The transmission path (8) refers to a transmission path including the transmission terminal 11 (Tx2), relay node D, relay node C, relay node B, relay node A, and reception terminal 12 (Rx2) in this order as shown in FIG. 13.

Comparing FIG. 11 to FIG. 13, the transmission terminal 11 (Tx1) and the reception terminal 11 (Tx2) move during a period from a state at the time 1 illustrated in FIG. 11 and a state at the time 2 illustrated in FIG. 13. In particular, the transmission terminal 11 (Tx1) moves from a position at which it is connected to the relay node A to a position at which it is connected to the relay node F, and transmission terminal 11 (Tx2) moves from a position at which it is connected to the relay node C to a position at which it is connected to the relay node D.

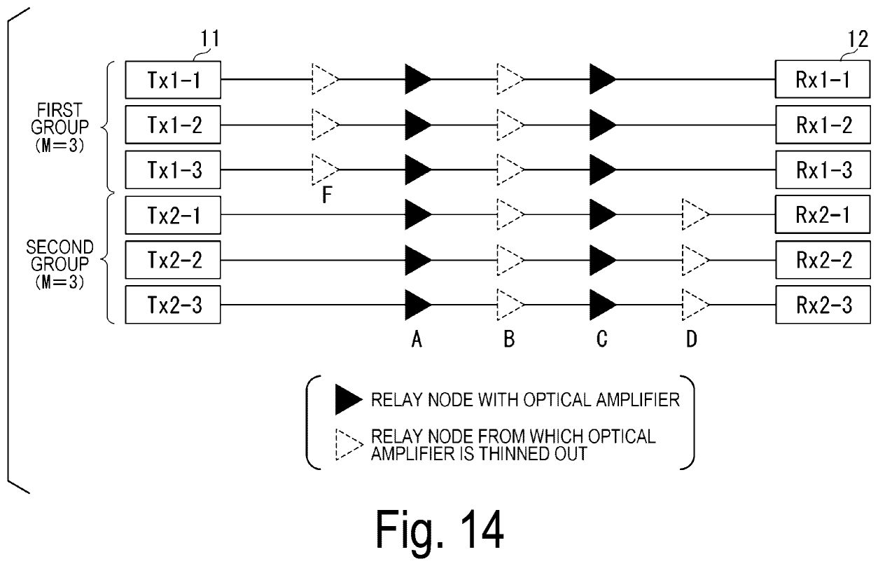

As in the related art, in a case where it is attempted to reduce the number of optical amplifiers 14 per optical fiber, the number of required optical amplifiers 14 is dedicated to the relay nodes A and C, and each transmission path requires three optical amplifiers 14 as illustrated in, for example, FIG. 14. FIG. 14 is a diagram illustrating one example of arrangement of optical amplifiers in the conventional optical transmission system. FIG. 14 shows the transmission terminals 11 (Tx1-1 to 1-3 and Tx2-1 to 2-3) that are user terminals on the transmission side, the reception terminals 12 (Rx1-1 to 1-3 and Rx2-1 to 2-3) that are user terminals on the reception side, and five relay nodes 83 (relay nodes A to D and F). These five relay nodes 83 relay transmission of optical signals from the transmission terminals 81 (Tx1-1 to 1-3 and Tx 2-1 to 2-3) to the reception terminals 82 (Rx1-1 to 1-3 and Rx2-1 to 2-3).

As described above, in a case where it is attempted to install the optical amplifiers 14 so that the number of optical amplifiers is reduced for each optical fiber, a position of the relay node 13 to which the optical amplifiers 14 are dedicated also changes over time in the network in which the transmission path is switched over time. Therefore, the number of optical amplifiers 14 to be prepared for each relay node 13 cannot be reduced in advance, and it is difficult to enable device cost reduction and space saving.

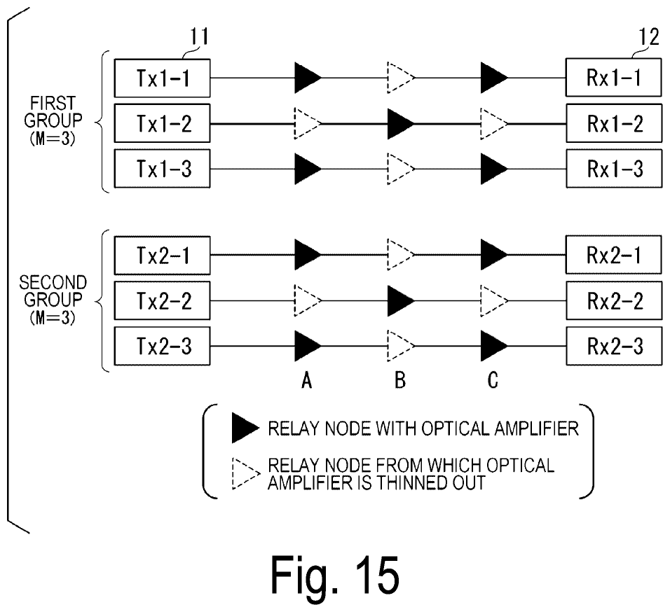

On the other hand, similarly to the first embodiment, a case where the number of optical amplifiers is optimized for each optical fiber group, instead of each optical fiber will be described. Similarly to the first embodiment, in each of the transmission paths (5) and (6) as illustrated in FIG. 11, M optical fibers are grouped as one group. In each group, the upper limit of the number of available optical amplifiers 14 for each relay node 13 is assumed to be N. FIG. 15 illustrates one example where the optical amplifiers 14 are thinned out under such conditions.

FIG. 15 is a diagram illustrating one example of the arrangement of the optical amplifiers 14 in the optical transmission system 1 according to the second embodiment of the present invention. FIG. 15 shows the transmission terminals 11 (Tx1-1 to 1-3 and Tx2-1 to 2-3) that are user terminals on the transmission side, the reception terminals 12 (Rx1-1 to 1-3 and Rx2-1 to 2-3) that are user terminals on the reception side, and three relay nodes 83. These three relay nodes 83 relay transmission of optical signals from the transmission terminals 81 (Tx1-1 to 1-3 and Tx 2-1 to 2-3) to the reception terminals 82 (Rx1-1 to 1-3 and Rx2-1 to 2-3).

FIG. 15 illustrates a case where M=3 and N=2. FIG. 15 illustrates a first group in which three optical fibers included in the transmission path from the transmission terminal 11 (Tx1) to the reception terminal 12 (Rx1) are grouped, and a second group in which three optical fibers included in the transmission path from the transmission terminal 11 (Tx2) to the reception terminal 12 (Rx2) are grouped.

In this case, the number of optical amplifiers 14 arranged in the relay node 13 in the first group and the number of optical amplifiers 14 arranged in the relay node 13 in the second group are each always not more than N. For example, as illustrated in FIG. 15, two optical amplifiers 14 are required for each group in the relay nodes A and C, and one optical amplifier 14 is required for each group in the relay node B.

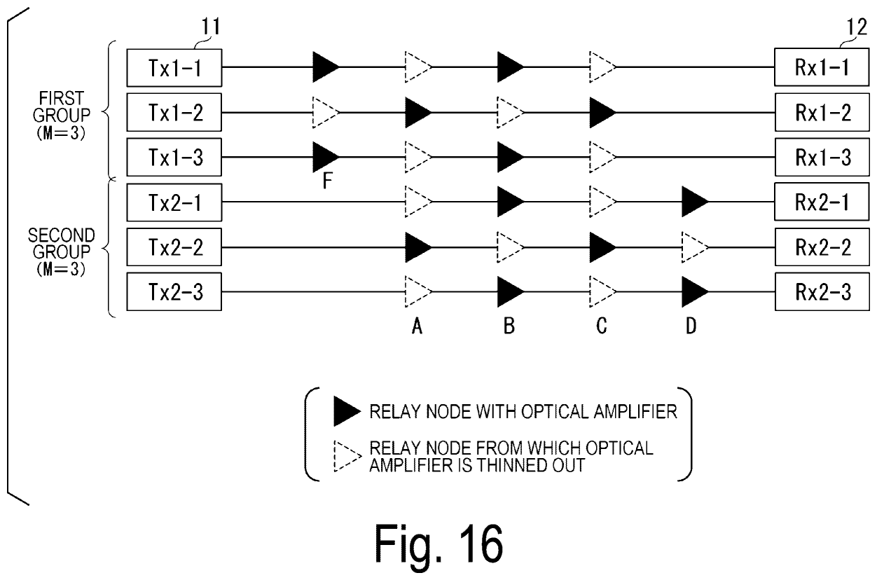

Similarly to the above, in each of the transmission paths (7) and (8) as illustrated in FIG. 13, M optical fibers are grouped as one group. In each group, the upper limit of the number of available optical amplifiers 14 for each relay node 13 is assumed to be N. FIG. 16 illustrates one example where the optical amplifiers 14 are thinned out under such conditions.

FIG. 16 is a diagram illustrating one example of the arrangement of the optical amplifiers 14 in the optical transmission system 1 according to the second embodiment of the present invention. FIG. 16 shows the transmission terminals 11 (Tx1-1 to 1-3 and Tx2-1 to 2-3) that are user terminals on the transmission side, the reception terminals 12 (Rx1-1 to 1-3 and Rx2-1 to 2-3) that are user terminals on the reception side, and six relay nodes 83 (relay nodes A to D and F). These three relay nodes 83 relay transmission of optical signals from the transmission terminals 81 (Tx1-1 to 1-3 and Tx 2-1 to 2-3) to the reception terminals 82 (Rx1-1 to 1-3 and Rx2-1 to 2-3).

FIG. 16 illustrates a case where M=3 and N=2. FIG. 16 illustrates a first group in which three optical fibers included in the transmission path from the transmission terminal 11 (Tx1) to the reception terminal 12 (Rx1) are grouped, and a second group in which three optical fibers included in the transmission path from the transmission terminal 11 (Tx2) to the reception terminal 12 (Rx2) are grouped.

In this case, since the upper limit of available optical amplifiers 14 for each relay node 13 in each group is N as described above, the number of optical amplifiers 14 arranged in the relay node 13 in the first group and the number of optical amplifiers 14 arranged in the relay node 13 in the second group are each always not more than N. For example, as illustrated in FIG. 16, two optical amplifiers 14 are required for each group in the relay nodes B, D and F, and one optical amplifier 14 is required for each group in the relay nodes A and C.

According to the second embodiment, it is possible to prevent the optical amplifiers 14 from being dedicated to the specific relay node 13 by dispersedly arranging the optical amplifiers 14 for the plurality of optical fibers upon switching the transmission path, thereby reducing the number of optical amplifiers 14 provided at the relay node 13 to be not more than N.

The example where M=3 and N=2 has been presented, however the configuration is not limited thereto. That is, as long as the condition where “M optical fibers are grouped as one group in each transmission path and the upper limit of the number m of available optical amplifiers 14 for each relay node in each group is N” is satisfied, the arrangement of the relay nodes 13 provided with the optical amplifiers 14 is not limited to the above example.

As described above, the optical transmission system according to the second embodiment of the present invention can appropriately thin out the optical amplifiers 14 in the network in which positions of user terminals and transmission paths change over time. The optical transmission system groups the adjacent optical fibers passing through the same relay node 13 as one group, and determines the arrangement of the optical amplifiers 14 per group, not per optical fiber. As described above, the optical transmission system prevents the optical amplifiers 14 from being dedicated to the specific relay node 13 by dispersedly arranging the optical amplifiers 14 provided at the relay node 13 for each group.

The optical transmission system according to the second embodiment determines the arrangement of the optical amplifiers 14 so that the number of optical amplifiers 14 for each relay node 13 becomes, for example, not more than N. The optical transmission system sets the number of optical fibers to be grouped to M and the upper limit of the number of optical amplifiers 14 for each relay node 13 of each group to N, and performs calculation such as transmission simulation for all possible patterns that can be made from combinations of M and N values.

Accordingly, the optical transmission system is capable of finding a combination that the optical amplifiers 14 can be installed to enable error-free transmission and the number of optical amplifiers 14 can be further reduced. Therefore, the optical transmission system according to the second embodiment of the present invention can reduce the number of optical amplifiers 14 to be provided at the relay node 13.

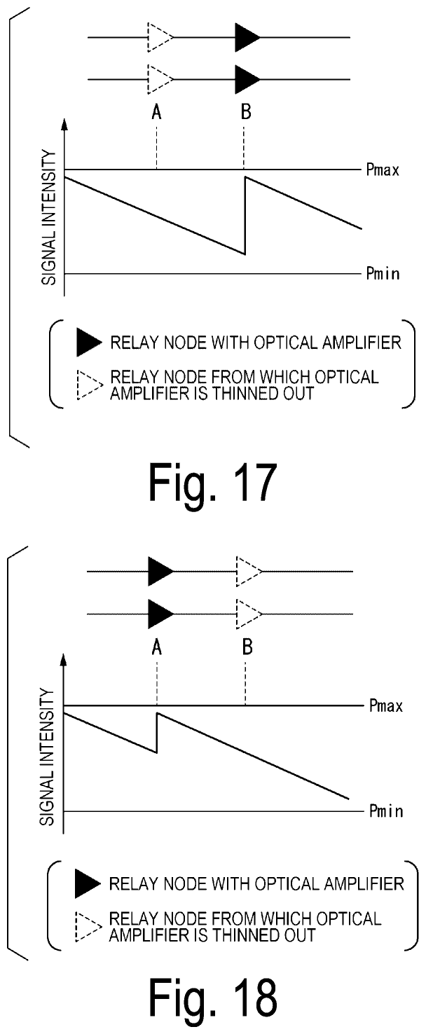

In the first embodiment and the second embodiment described above, all the relay nodes 13 between the transmission terminal 11 (Tx) and the reception terminal 12 (Rx) have been considered, but only some of the relay nodes 13 in the transmission path may be considered. FIG. 17 is a diagram illustrating another example of the arrangement of the optical amplifiers in the optical transmission system according to each embodiment of the present invention.

In particular, for example, the optical amplifier 14 is thinned out from the relay node A, while the optical amplifier 14 is provided in the relay node B adjacent to the relay node A, as illustrated in FIG. 17. As illustrated in the lower part of FIG. 17, for example, the transition of the signal intensity in this case falls between Pmax and Pmin, thereby transmitting optical signals without error.

In contrast to the configuration illustrated in FIG. 17 as described above, for example, it is assumed that the relay node 13 including the optical amplifier 14 is changed from the relay node B to the relay node A as illustrated in FIG. 18. FIG. 18 is a diagram illustrating another example of the arrangement of the optical amplifiers in the optical transmission system according to each embodiment of the present invention. As illustrated in the lower part of FIG. 18, for example, the transition of the signal intensity in this case also falls between Pmax and Pmin, thereby transmitting optical signals without error.

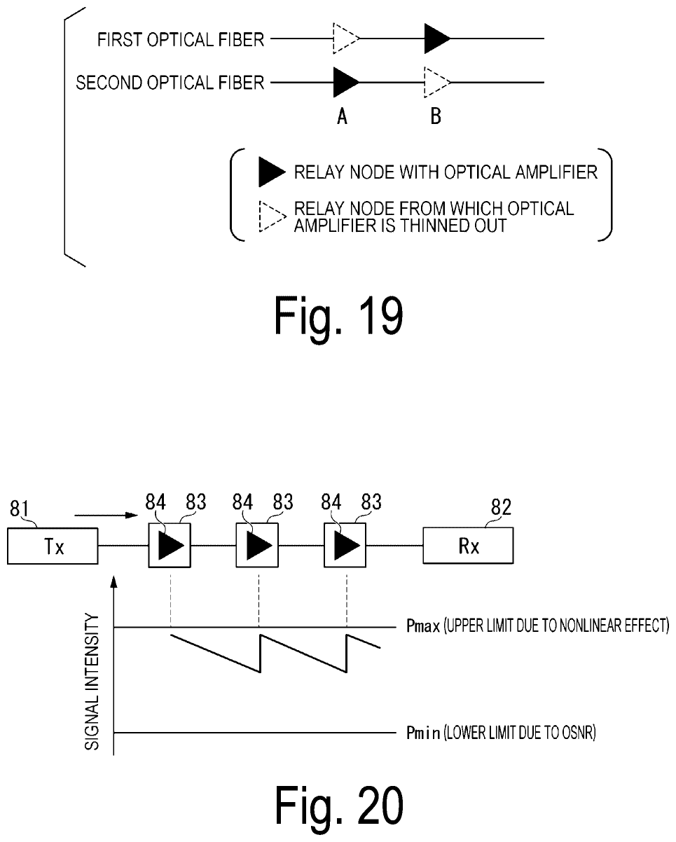

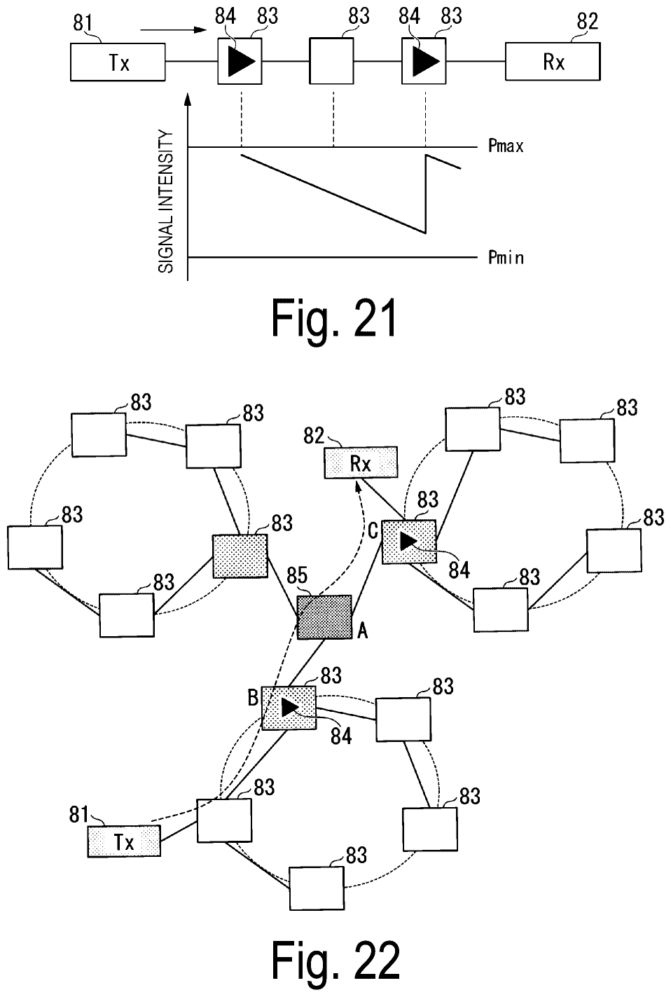

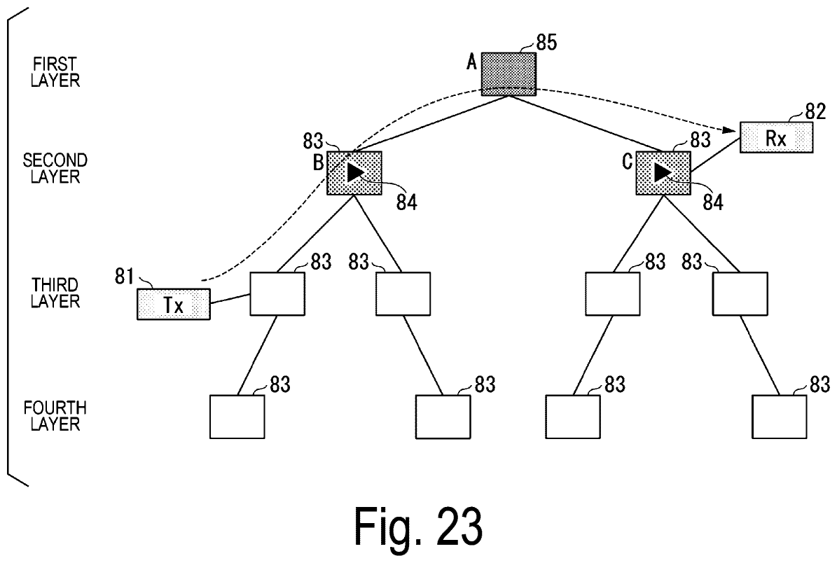

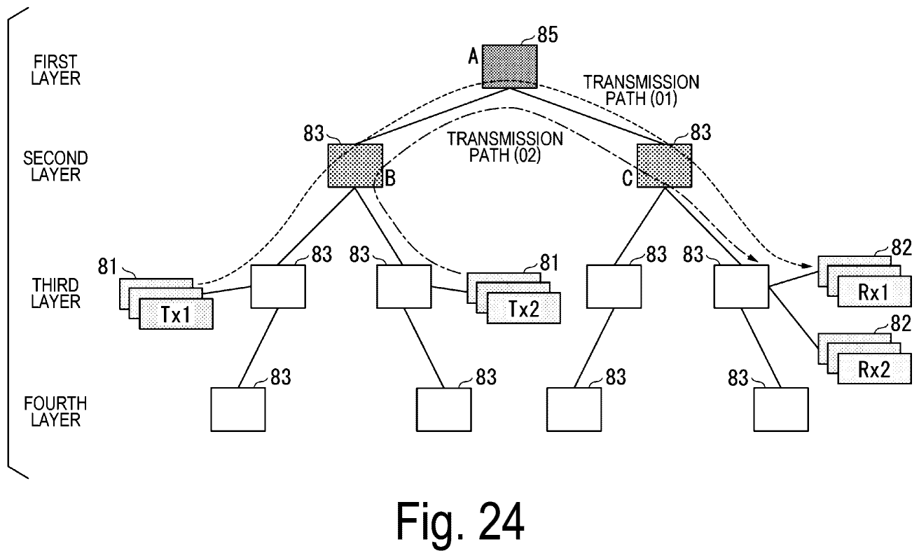

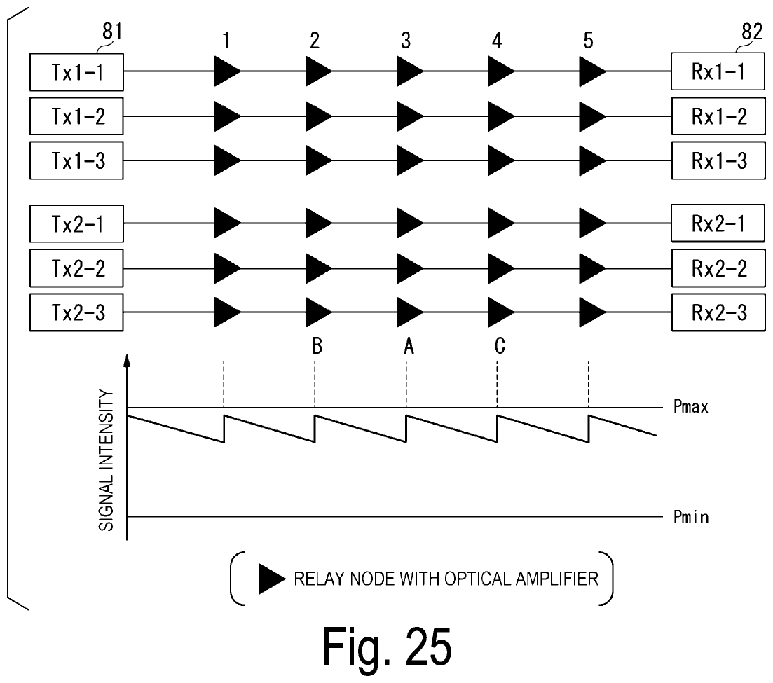

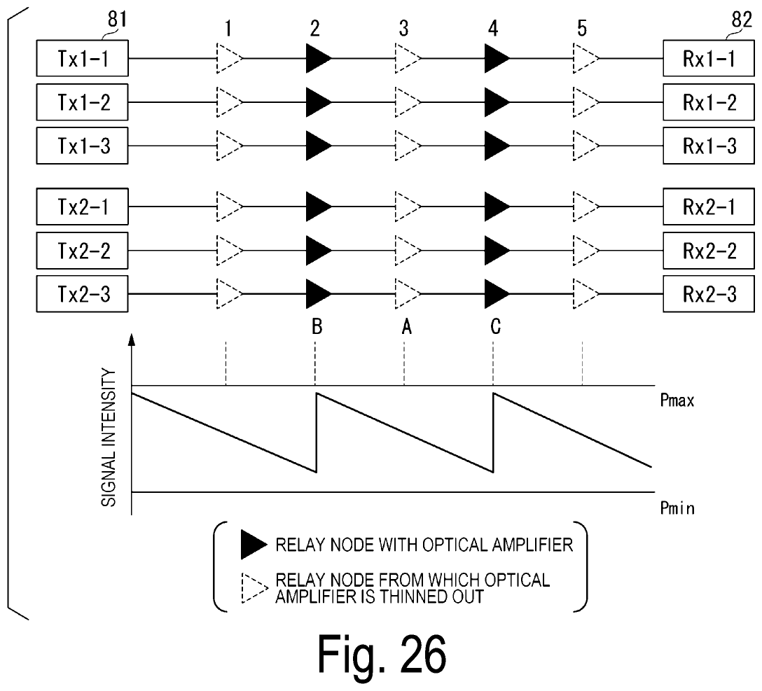

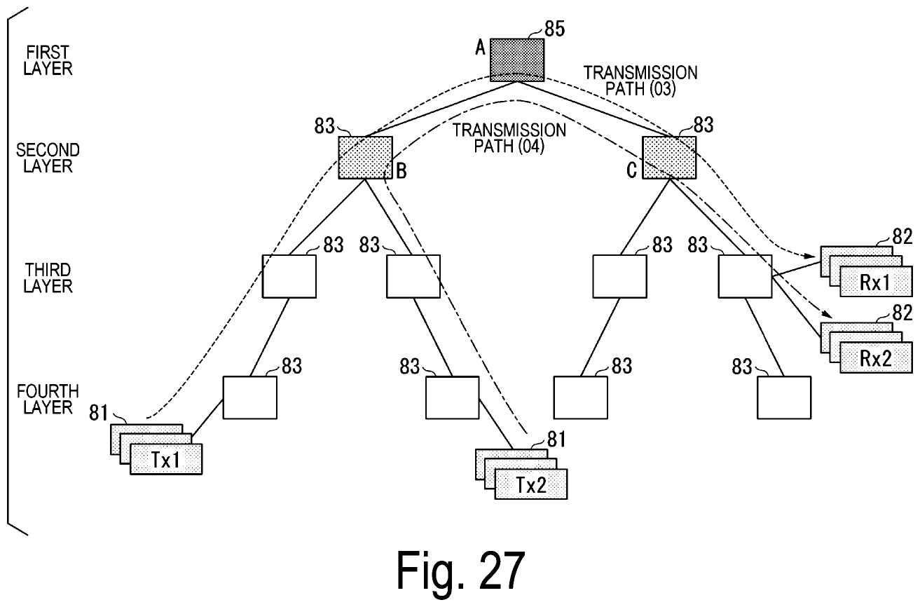

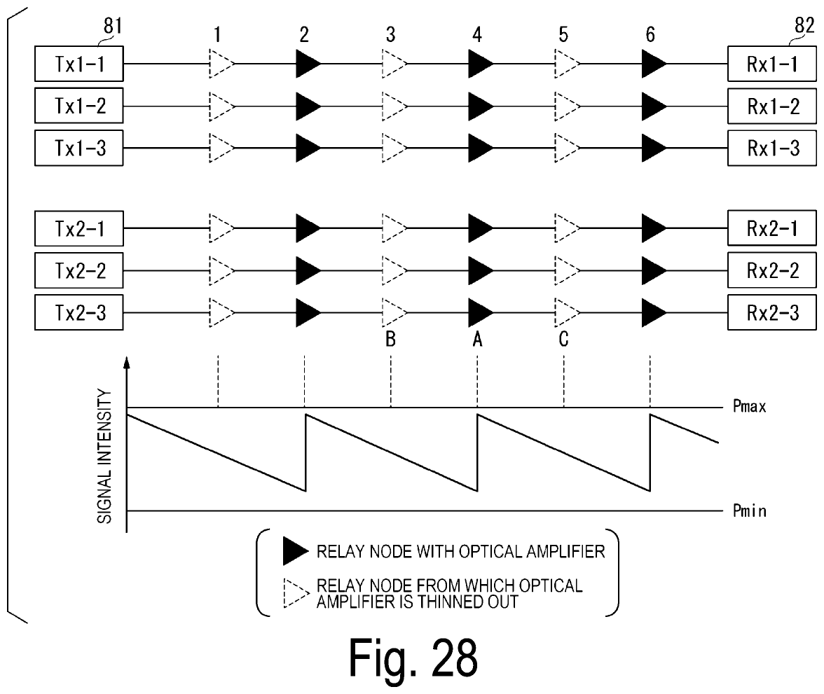

As described above, in a case where error-free transmission is enabled even when the relay node 13 with the optical amplifier 14 arranged is switched, it is possible to prevent the optical amplifiers 14 from being dedicated to the specific relay node 13 by performing such switching. FIG. 19 is a diagram illustrating another example of the arrangement of the optical amplifiers in the optical transmission system according to each embodiment of the present invention. For example, as illustrated in FIG. 19, for only one optical fiber (second optical fiber in FIG. 19), it is possible to prevent the optical amplifiers 14 from being dedicated to the specific relay node 13 (for example, the relay node B) by changing the relay node 13 with the optical amplifier 14 from the relay node B to the relay node A.

According to the embodiments described above, the optical amplifier arrangement assistant device (the optical amplifier placement support apparatus) includes an acquisition unit and a determination unit. For example, the optical amplifier arrangement assistant device is the relay node 13 or another device other than the relay node 13 in the embodiment, the acquisition unit is the transmission path information acquisition unit 135 in the embodiment, and the determination unit is the optical amplifier requirement determination unit 136.

In the acquisition step, transmission path information indicating a configuration of a network that transmits an optical signal via a plurality of relay nodes and a transmission path of the optical signal transmitted by the network is acquired. For example, the relay node is the relay node 13 in the embodiment, and the network is the all-optical network in the embodiment. The determination unit groups a plurality of optical fibers passing through the same relay node on the basis of the transmission path information, and determines whether optical amplification is required per relay node for each optical fiber group to determine the arrangement of the optical amplifiers in the network. For example, groups are the first group and the second group in the embodiment, and the optical amplifier is the optical amplifier 14 in the embodiment.

Moreover, the determination unit may perform, in a case where the number of optical fibers grouped in the relay node is M and the number of optical amplifiers per relay node of each group is N, simulation of transmission of the optical signal for possible patterns made by combinations of M and N values, and determine the arrangement of the optical amplifiers on the basis of simulation results.

Furthermore, the determination unit may calculate a bit error rate in the receiver for receiving the optical signal for each of the patterns by means of the simulation, and may determine the arrangement of the optical amplifiers based on the calculated bit error rate. For example, the receiver is the reception terminal 12 (Rx) and the transceiver terminal 10 (TRx) in the embodiment.

The determination unit may determine the arrangement of the optical amplifiers such that the signal intensity of the optical signal passing through the relay node is not less than the signal intensity at which the bit error rate increases due to a decrease in the optical signal-to-noise ratio (OSNR).

The determination unit may determine the arrangement of the optical amplifiers such that a signal intensity of the optical signal passing through the relay node is not more than a signal intensity influenced by a nonlinear optical effect.

Apart of the optical transmission system in each embodiment described above may be implemented by a computer. In that case, a program for implementing this function may be recorded in a computer-readable recording medium, and the program recorded in the recording medium may be read and executed by a computer system to implement the function. Note that the “computer system” mentioned herein includes an OS and hardware such as peripheral devices. Also, the “computer-readable recording medium” is a portable medium such as a flexible disk, a magneto-optical disc, a ROM, or a CD-ROM, or a storage device such as a hard disk embedded in the computer system. Further, the “computer-readable recording medium” may include a medium that dynamically holds the program for a short time, such as a communication line in a case where the program is transmitted via a network such as the Internet or a communication line such as a telephone line, and a medium that holds the program for a certain period of time, such as a volatile memory inside a computer system serving as a server or a client in that case. In addition, the program may be for implementing a part of the functions described above, may be able to implement the functions described above by a combination with a program already recorded in the computer system, or may be implemented by using a programmable logic device such as a field programmable gate array (FPGA).

As described above, the embodiments of the present invention have been described in detail with reference to the drawings. On the other hand, the specific configuration is not limited to the embodiments, and includes design without departing from the spirit of the present invention.

### REFERENCE SIGNS LIST

1 Optical transmission system
10 Transceiver terminal
11 Transmission terminal
12 Reception terminal
13 Relay node
14 Optical amplifier
15 Concentrator
81 Transmission terminal
82 Reception terminal
83 Relay node
84 Optical amplifier
85 Concentrator
130-1 to 3 Input/output port
131 Circulator
132 Optical switch
135 Transmission path information acquisition unit
136 Optical amplifier requirement determination unit
137 Optical switch control unit

1. An optical amplifier arrangement method, comprising:
an acquisition step of acquiring transmission path information indicating a configuration of a network that transmits an optical signal via a plurality of relay nodes and a transmission path of the optical signal transmitted by the network; and
a determination step of determining arrangement of optical amplifiers in the network by grouping a plurality of optical fibers passing through the same relay node based on the transmission path information, and determining whether optical amplification is required in each of the relay nodes for each group of the optical fibers.

2. The optical amplifier arrangement method according to claim 1, wherein
in the determination step, in a case where the number of optical fibers grouped in the relay node is M and the number of optical amplifiers per relay node of each group is N, transmission of the optical signal is simulated for possible patterns made by combinations of M and N values, and the arrangement of the optical amplifiers is determined on the basis of simulation results.

3. The optical amplifier arrangement method according to claim 2, wherein
in the determination step, a bit error rate in a receiver for receiving the optical signal is calculated for each of the patterns by means of the simulation, and the arrangement of the optical amplifiers is determined based on the calculated bit error rate.

4. The optical amplifier arrangement method according to claim 3, wherein
in the determination step, the arrangement of the optical amplifiers is determined such that a signal intensity of the optical signal passing through the relay node is not less than a signal intensity at which the bit error rate increases due to a decrease in an optical signal-to-noise ratio.

5. The optical amplifier arrangement method according to claim 3, wherein
in the determination step, the arrangement of the optical amplifiers is determined such that a signal intensity of the optical signal passing through the relay node is not more than a signal intensity influenced by a nonlinear optical effect.

6. An optical amplifier arrangement assistant device, comprising:
an acquire configured to acquire transmission path information indicating a configuration of a network that transmits an optical signal via a plurality of relay nodes and a transmission path of the optical signal transmitted by the network; and
a determine configured to determine arrangement of optical amplifiers in the network by grouping a plurality of optical fibers passing through the same relay node based on the transmission path information, and to determine whether optical amplification is required in each of the relay nodes for each group of the optical fibers.

7. A relay device, comprising:
an acquire configured to acquire transmission path information indicating a configuration of a network that transmits an optical signal via a plurality of relay devices and a transmission path of the optical signal transmitted by the network; and
a determine configured to determine arrangement of optical amplifiers in the network by grouping a plurality of optical fibers passing through this device itself or a plurality of optical fibers passing through the same relay device other than this device, based on the transmission path information, and to determine whether optical amplification is required in each of the relay devices for each group of the optical fibers.
